(19) United States
(12) Patent Application Publication
(10) Pub. No.: US 2008/0257795 A1
(43) Pub. Date: Oct. 23, 2008

(54) Multiple Zone and Multiple Materials Sorting

(75) Inventor: Tim Shuttleworth, Girard, PA (US)

Correspondence Address: EDWARD W. GOEBEL, JR.;MACDONALD, ILLIG, JONES & BRITTON LLP, 100 STATE STREET, SUITE 700, ERIE, PA, 16507-1498, US

(73) Assignee: Eriez Manufacturing Co.

(21) Appl. No.: 12/105,021

(22) Filed: Apr. 17, 2008

Related U.S. Application Data
(60) Provisional application No. 60/912,247, filed on Apr. 17, 2007.

(51) Int. Cl. B07C 5/34

(52) U.S. Cl. 209/576

(57) ABSTRACT

A method and system of sorting materials from a material stream on a sorter is provided. The material stream includes a plurality of components and the sorter is able to detect and sort at least one component in the material stream. The sorter includes a first detection zone and an adjacent second detection zone on the sorter. Each detection zone sorts at least one component from the material stream. The material stream is introduced to the first detection zone of the sorter. The sorter substantially sorts at least one component from the material stream in the first detection zone by removing at least one component of the material stream from the sorter. The remaining material stream is returned to the second detection zone of the sorter where it is substantially sorted by removing at least one component of the remaining material stream from the sorter.

This application takes priority from U.S. provisional application 60/912,247 filed Apr. 17, 2007, which is incorporated herein by reference.

### BACKGROUND

The recycling industry sorts and separates reusable materials out of collected materials. The sorted and separated reusable materials are reprocessed into raw materials in other applications while the unusable material is typically sent to a landfill. Machines, called sorters, are often used to mechanically sort and separate a variety of types of materials from a material stream. Such machines typically use a variety of methods to move the material stream including conveyors to mechanically move the material stream or sloping chutes to move the material stream by gravity. The material stream is passed through the detection range of any of a variety of sensors that detect metals, plastics, glass, or other parameters like size and color that can be sorted and separated from the material stream.

### SUMMARY

A method and system of sorting materials from a material stream on a sorter is provided. The material stream includes a plurality of components and the sorter is able to detect and sort at least one component of the material stream. The sorter includes a first detection zone and an adjacent second detection zone on the sorter. Each detection zone sorts at least one component from the material stream. The material stream is introduced to the first detection zone of the sorter. The sorter substantially sorts at least one component from the material stream in the first detection zone by removing at least one component of the material stream from the sorter. The remaining material stream is returned to the second detection zone of the sorter where it is substantially sorted a second time by removing at least one component of the remaining material stream from the sorter.

The sorter may have more than two detection zones, in which case portions of the material stream are returned to the sorter for processing within each detection zone based on the material detector system readings for that zone. If desired, the material stream may be returned by a series of conveyors that collect and transfer portions of the sorted material stream back to the sorter. Alternatively the material stream may be returned by a collection of bins that are manually transferred to the appropriate detection zone for further processing. Other material handling systems are also possible.

Those skilled in the art will realize that this invention is capable of embodiments that are different from those shown and that details of the devices and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 is a schematic view of a sorting device with material detectors defining two detection zones for sorting two types of materials from a material stream;

FIG. 2 is a cross sectional top view of the sorting device of FIG. 1 showing an array of sensors across the width of the material handling system; and

FIG. 3 is a schematic view of a sorting device with material detectors defining two detection zones for sorting more than two types of materials from a material stream.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

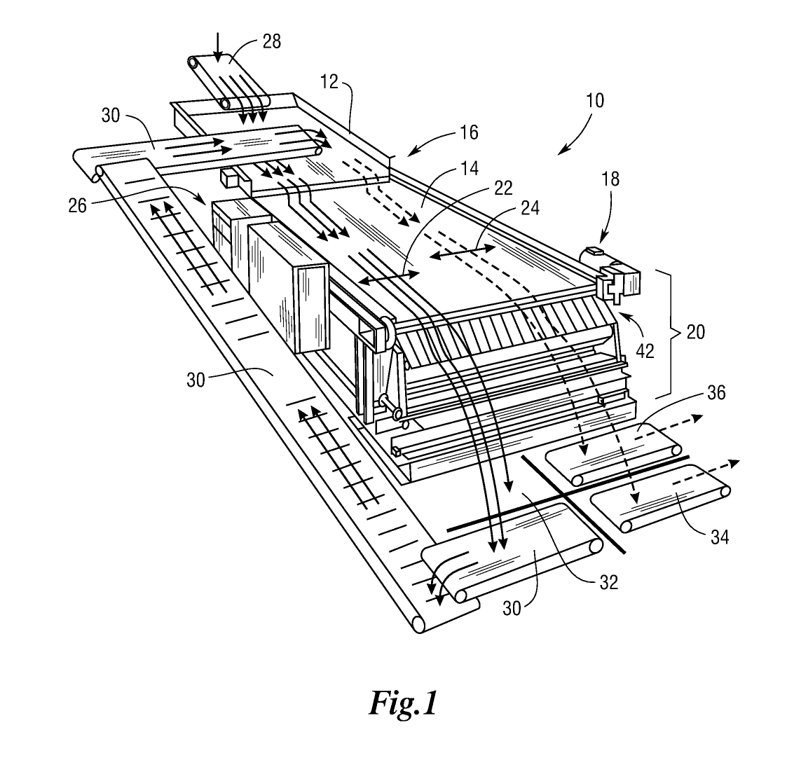

FIG. 1 shows one embodiment in which a new or existing sorter machine 10 has been configured to sort multiple materials in multiple zones. The sorter machine 10 is a ProSort manufactured by Eriez Magnetics, however, any sorter having definable detection zones as described herein may be used. The sorter machine 10 has a material introduction system 12 that is a vibrating chute angled to deposit a material stream onto a material handling system 14. The material handling system 14 comprises a conveyor belt that transports the material stream from about a first end 16 where the material stream is deposited to about a second end 18 where the material stream is sorted by a sorting system 20. It will be understood that any other means than shown may be used for the material introduction system 12 and the material handling system 14.

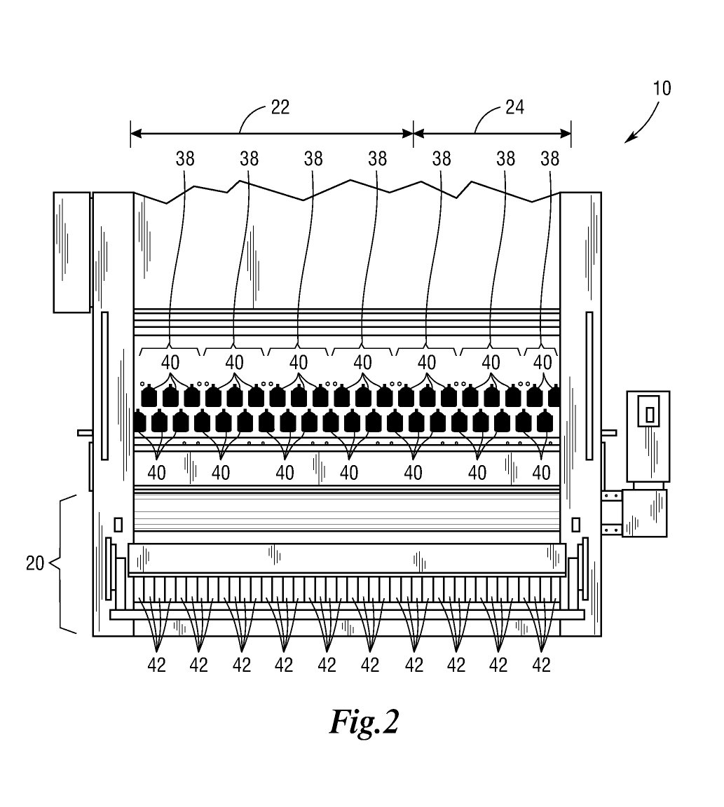

FIG. 2 shows a cross sectional top view of the material detection system and the sorting system 20 of the sorter 10. As best understood by comparing FIGS. 1 and 2, the material detector system on this sorter machine 10 comprises an array of seven control modules 38 across the width of the material handling system 14. Each control module 38 comprises six individual sensors 40, with the exception of the seventh control module 38 that comprises four individual sensors 40. It will be understood that the number of sensors in each control module 38 is arbitrary and can be defined on a case-by-case basis. Any sorter machine 10 that can configure its material detector system into at least two adjacent detection zones would be equally able to perform various embodiments of the invention.

The sensors 40 are connected to the sorting system 20 (described in more detail below). Each control module 38 is adjustable to detect a certain component of the material stream therefore a system comprising seven control modules 38 could define up to seven adjacent detection zones. Each detection zone delineates a portion of the width of the material handling system 12. In this embodiment, the sensors are located along the lines that define the first detection zone 22 and the second detection zone 24 with the first four control modules 38 defining the first detection zone 22 and the last three control modules 38 defining the second detection zone 24. Each detection zone can be physically separated by dividers (not shown) to keep the material streams in each detection zone from mixing on the material handling system 14 and/or the material introduction system 12. The embodiment described above is not limited to metal detection systems that comprise modular control systems. Sorters that have detection systems with a single Programmable Logic Controller (PLC) that controls all of the sensors across the width of the material handling system can be programmed to define detection zones as described above.

The sorting system 20 of the sorter machine 10 shown comprises a series of paddles 42 that are each controlled by a single sensor 40. Each paddle 42 is about two inches wide. Therefore each control module 38 can define a detection zone of about twelve inches wide. In this embodiment, the first detection zone 22 is about four feet wide and the second detection zone 24 is about two feet eight inches wide. The material detector system and the sorting system 20 are controlled by the control system 26.

The sorter machine 10 is often used as a step in sorting materials in a material stream that has already been somewhat processed to remove the largest and smallest materials. So the material stream that this sorter machine 10 handles is typically about ½ inch to 2 feet wide, but the method described herein is easily applicable to any sized material stream so long as the sorter machine 10 is able to process the material. The sensors 40 on the ProSort machine are typically inductive sensors that can distinguish metals from non-metals in one zone and stainless steel from other metals in a second zone. But any other kinds of sensors detecting any other kinds of materials can be used.

A conveyor 28 from an upstream process introduces the material stream to the sorter machine 10 at the material introduction system 12. The material stream is deposited at about the first end 16 of the sorter machine 10 on the material handling system 14 in such a way as to substantially limit the material stream to the first detection zone 22. The material stream passes through the detection range of the material detector system as it is conveyed from the first end 16 to the second end 18. When a sensor 40 of the material detector system detects a target component in the material stream, the control system 26 either sends a timed signal to the corresponding paddle 42 in the sorter system 20 to deflect the material or does nothing and lets the material drop past the paddles 42 as required by the current configuration of the sorter machine 10.

Although many sorters that have detection systems are able to distinguish more than one kind of material from a materials stream, they are unable to distinguish more than one kind of material at the same time. For example, some sorting machines incorporating material detectors that have inductive sensors can distinguish 1) all metals from a materials stream and 2) stainless steel from other metals, but are not equipped to be able to sort both stainless steel and other metals from a materials stream at the same time. To work around this problem, the material stream is processed twice through the sorter, with a first pass to sort out all the metals from the material stream and a second, or re-pass, to sort out the stainless steel from the metals. This solution requires the sorters to operate in a batch mode, i.e. the materials stream is completely processed before it is re-passed through the system. This is a bottleneck in the system that adds to operating expense. Another solution is to use two sorters in series, with the first sorter to remove all metals from the material stream and the second sorter to remove any stainless steel from the sorted metals. However this requires the expenditure to purchase, install, and operate two machines and takes up valuable floor space.

In contrast, the embodiment depicted in FIGS. 1 and 2 would allow for sorting multiple materials simultaneously and potentially continuously on the same machine. For the purposes of illustration, if the material stream comprises a mix of metals and non-metals with the metals including stainless steel and other metals, the sensors 40 in the first detection zone 22 can be configured to detect all metals in the first detection zone 22 from the material stream. The control system 26 can be set to direct the sorter system 20 to deflect all metals to a material return system 30. Any non-metals would drop past the sorter system 20 to a first collection system 32 (in this case a collection bin) and may be discarded or further processed as required. In the embodiment shown in FIG. 1, the material return system 30 comprises a series of conveyors that returns the prior deflected all metals to the material introduction system 12. The prior deflected all metals material stream is deposited at about the first end 16 of the sorter machine 10 on the material handling system 14 in such a way as to substantially limit the prior deflected all metals material stream to the second detection zone 24. The sensors 40 in the second detection zone 24 can be configured to detect all stainless steel from the prior deflected all metals material stream. The control system 26 can be set to direct the sorter system 20 to deflect all the stainless steel from the second detection zone 24 to an appropriate second collection system 34 (in this case a conveyor system) while any other metal product that does not trigger the detector system will drop past the sorter system 20 to a third collection system 36 (in this case another conveyor system).

This example allows sorters to be able to recover different products of a higher grade from a material stream and provide an additional income source for operators of such sorters. Some of the embodiments described herein can also be retro-fitted to existing sorters to be able to process multiple materials streams in multiple sorting zones and allow current operators to recover a higher grade of product from the same material stream without having to purchase additional sorters.

The collection areas for the sorter system 20 can be collection bins as with the first collection system 32 or conveyor belts as with the second and third collection systems 34 and 36. The material return system 30 can be a system of conveyor belts as shown in FIG. 1, or it can be a collection bin that is manually returned to the material introduction system 12 at the appropriate location. Other types of material return systems or collection area are also possible.

The size of the first and second detection zones 22 and 24 can be adjusted based on the expected composition of the material stream. For example if the facility that the sorter machine 10 is installed in expects a material stream that is known to have little or no stainless steel, the first detection zone 22 can be increased in size to cover a greater width of the material handling system 14. The second detection zone 24 would be correspondingly shortened. In this case the location and size of the material return system 30 and the collection systems 32, 34, and 36 would have to be appropriately adjusted to accommodate the change in size of the first and second detection zones 22 and 24.

It is also possible for the second detection zone 24 to be configured to detect the same component in the material stream as the first detection zone 22. In this scenario, either the material stream or the separated component of the material stream that has been sorted through the first detection zone 22 is returned to the second detection zone 24 and processed a second time to further remove any residual material not successfully separated the first time. This provides a higher capture of a target component or a more thorough removal of a target component from a material stream.

It is also possible to define more detection zones than the two depicted in FIG. 1. This would allow for further sorting of components of the material stream in the detection system. In such embodiments, the material return system would have to be configured to return each round of sorted material to the appropriate consecutive detection zone.

There are many types of sorters that separate recyclable materials from material streams using a variety of technologies. While the detection system described in FIG. 1 was shown by example to detect metals and stainless steel from a material stream, the material detector system can generally be any component or system that can distinguish one or more materials from other materials and produce a digital or analog signal to indicate the presence of the distinguished material. The detection system can comprise an induction system, an X-Ray Fluorescence system, an optical detection system, a near-infrared detection system, or any other kind of detection technology. The detection system could also comprise a combination of technologies with, for example, a different sensor technology for each detection zone.

The sorter is not limited to the sorter system depicted in FIG. 1. Any other type of sorting system is equally applicable. The sorter system could comprise a series of nozzles that shoot jets of compressed air to deflect material in a material stream based on a signal from the detection system. The sorting system could be an electromagnetic system that is actuated by a signal from the detection system to deflect target metals. The sorter could be any other kind of system that can deflect or otherwise sort materials for collection or return.

The material handling system is not limited to a conveyor belt as depicted in FIG. 1. Any other type of material handling system is equally applicable. For example, the material handling system could be a chute that moves the material stream by gravity past the detection system and to the sorting system. Any other kind of material handling system that can move the material stream through the detection system to an appropriate sorting system would also work.

The sorter is not limited to metals as described in the example above. Any kind of detectable parameter may be used to sort a material stream. The sensors can be configured to detect metal, plastics, glass, the size of the material in the material stream, the color of the material in the material stream, or other detectable parameter as required by the particular application.

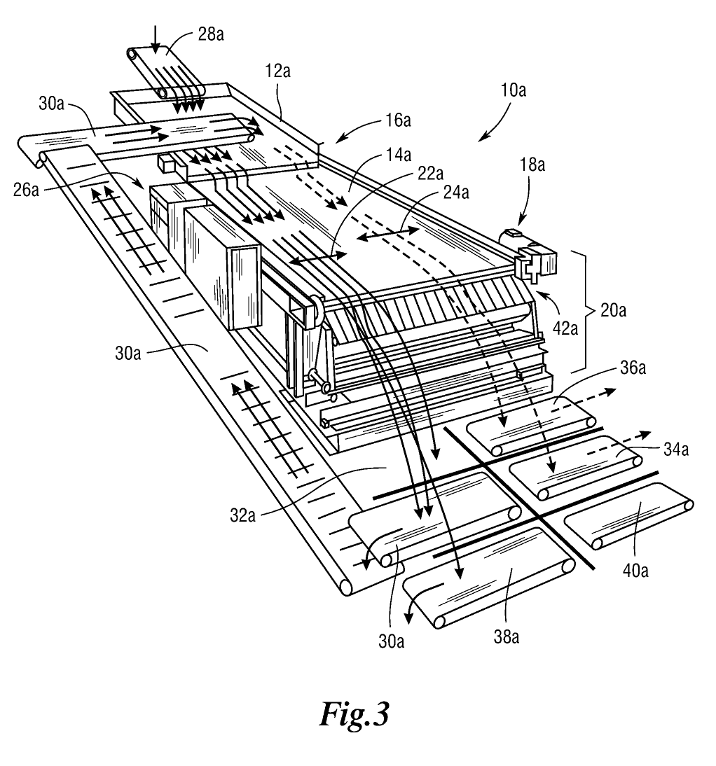

Some sorters can sort more than one type of material from a material stream. FIG. 3 shows an embodiment of how such sorters can be used. For the purposes of illustration, if the material stream comprises a mix of metals, plastics, and other debris with the metals including stainless steel and other metals, the sensors in the first detection zone 22a can be configured to detect all metals and plastics in the first detection zone 22a from the material stream. The control system 26a can be set to direct the sorter system 20a to deflect all metals to a material return system 30a and to deflect the plastics to a plastics collection system 38a for separate processing or collection as needed. Any other debris would drop past the sorter system 20a to a first collection system 32a (in this case a collection bin) and may be discarded or further processed as required. In the embodiment shown in FIG. 3, the material return system 30a comprises a series of conveyors that returns the prior deflected all metals to the material introduction system 12a. The prior deflected all metals material stream is deposited at about the first end 16a of the sorter machine 10a on the material handling system 14a in such a way as to substantially limit the prior deflected all metals material stream to the second detection zone 24a. The sensors (not shown) in the second detection zone 24a can be configured to detect all stainless steel from the prior deflected all metals material stream. The control system 26a can be set to direct the sorter system 20a to deflect all the stainless steel from the second detection zone 24a to an appropriate second collection system 34a (in this case a conveyor system) while any other metal product that does not trigger the detector system will drop past the sorter system 20a to a third collection system 36a (in this case another conveyor system). If another component of the prior deflected all metals material stream can be detected and there is some commercial value to doing so, the sorter system 20a can be programmed to sort this additional component into a fourth collection system 40a. The choices of materials in this embodiment are for example purposes only. The limitations on what materials can be sorted will depend on the particular material stream observed by the facility, the ability of the sensors to detect the various components of the material stream, and the ability of the sorter system to appropriately deflect the detected material into appropriate collection and/or return systems.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A method of sorting materials from a material stream on a sorter, the material stream includes a plurality of components, the sorter able to detect and sort at least one component of the material stream, the method comprising:
defining a first detection zone and an adjacent second detection zone on the sorter;
introducing the material stream to the first detection zone of the sorter;
substantially sorting at least one component from the material stream in the first detection zone;
removing at least one component from the material stream from the first detection zone;
returning the remaining material stream to the second detection zone;
substantially sorting at least one component from the remaining material stream in the second detection zone; and
removing at least one component from the remaining material stream from the second detection zone.

2. The method of claim 1 further comprising:
defining a third detection zone on the sorter adjacent the first and second detection zones;
returning the remaining material stream from the second detection zone to the third detection zone;
substantially sorting at least one component from the remaining material stream in the third detection zone;
removing at least one component from the remaining material stream from the third detection zone.

3. The method of 1 further comprising:
defining more than two adjacent detection zones on the sorter;
substantially sorting at least one component from the remaining material stream in each detection zone;
removing at least one component from the material stream from each detection zone; and
returning the remaining material stream to the next detection zone if required.

4. The method of claim 1 further comprising:
substantially sorting at least two components from the material stream in the first detection zone; and
removing at least two components from the material stream from the first detection zone.

5. The method of claim 1 further comprising:
substantially sorting at least two components from the material stream in the second detection zone; and
removing at least two components from the remaining material stream from the second detection zone.

6. The method of claim 1 further comprising manually returning the remaining material stream to the second detection zone of the sorter.

7. The method of claim 1 further comprising returning the remaining material stream to the second detection zone of the sorter with a series of conveyor belts.

8. The method of claim 1 in which each detection zone sorts the same component in the material stream.

9. The method of claim 1 in which the first detection zone sorts a different component in the material stream from the second detection zone.

10. The method of claim 1 for sorting a type of material from the material stream from the group consisting of metal, plastics, glass, size, or color.

11. A sorter for sorting materials from a material stream, the material stream including a plurality of components, the sorter comprising:
a material introduction system, a material handling system, a material detector system capable of detecting at least one component in the material stream, a sorting system, a material return system, and a first detection zone and an adjacent second detection zone;
said material introduction system to deposit the material stream onto said material handling system substantially within said first detection zone,
said sorting system for substantially sorting a component in the material stream in said first detection zone based on the readings of said material detector system in said first detection zone by removing at least one component from the material stream and said sorting system to substantially sort a component in the material stream in said second detection zone based on the readings of said material detector system in said second detection zone; and
said first material return system to return the remaining material stream from said first detection zone to said second detection zone.

12. The sorter of claim 11 further comprising:
a third detection zone adjacent to said first detection zone and said second detection zone;
a second material return system to transfer the remaining material stream from said second detection zone to said third detection zone; and
said sorting system to substantially sort the component of the material stream in the said third detection zone based on the readings of said material detector system in said third detection zone by removing at least one component from the material stream.

13. The sorter of 11 further comprising:
more than two adjacent said detection zones, each said detection zone for sorting a component of the material stream, each said detection zone having a material return system if required to transfer the remaining material stream onto said material handling system substantially within the next said detection zone; and
said sorting system to substantially sort the component of the material stream in the corresponding said detection zone based on the readings of said material detector system in the corresponding said detection zone by removing at least one component from the material stream.

14. The sorter of claim 11 further comprising:
substantially sorting at least two components from the material stream in the first detection zone; and
removing at least two components from the material stream from said first detection zone.

15. The sorter of claim 11 further comprising:
substantially sorting at least two components from the material stream in the second detection zone; and
removing at least two components from the remaining material stream from said second detection zone.

16. The sorter of 11 in which said first detection zone and said second detection zone are configured to detect different components of the material stream.

17. The sorter of 11 in which said first detection zone and said second detection zone are configured to detect the same component of the material stream.

18. The sorter of 11 in which said material return system comprises a series of conveyor belts.

19. The sorter of 11 in which said material return system comprises a manual collection system.

20. The sorter of 11 in which said sorting system comprises a series of motorized paddles actuated based on the reading of said material detector.

21. The sorter of 11 in which said sorting system is a series of air nozzles actuated based on the reading of said material detector.

22. The sorter of 11 in which said material detector system comprises a series of sensors across the width of the material handling system.

23. The sorter of 11 in which said material detector system comprises a series of modules of sensors across the width of the material handling system.

24. The sorter of 11 in which said material detector system is an induction system, an X-Ray Fluorescence system, an optical detection system, or a near-infrared detection system.

25. The sorter of 11 in which said material detector system comprises more than one kind of detection technology.

26. The sorter of 11 in which said material detector system detects from the group consisting of metal, plastics, glass, size, or color.

27. The sorter of claim 11 further comprising physical dividers to separate each said detection zone.

28. A sorter for sorting materials from a material stream, the material stream including a plurality of components, the sorter comprising:
a first detection zone and an adjacent second detection zone;
a material detector means for detecting at least one component in the material stream
a material introduction means for depositing the material stream onto said material handling means substantially within said first detection zone,
a sorting means for substantially sorting a component in the material stream in said first detection zone based on the readings of said material detector system in said first detection zone and said sorting means for substantially sorting a component in the material stream in said second detection zone based on the readings of said material detector system in said second detection zone; and
a first material return means for returning the remaining material stream from said first detection zone to said second detection zone.

29. The sorter of claim 28 further comprising:
a third detection zone adjacent to said first detection zone and said second detection zone;
a second material return means for transferring the remaining material stream from said second detection zone to said third detection zone; and
said sorting means for substantially sorting the component of the material stream in the said third detection zone in said third detection zone.
